(19) United States
(12) Patent Application Publication
(10) Pub. No.: US 2013/0028825 A1
(43) Pub. Date: Jan. 31, 2013

(54) MANUFACTURING METHOD FOR POLYCRYSTALLINE SILICON INGOT, AND POLYCRYSTALLINE SILICON INGOT

(71) Applicants: Koji Tsuzukihashi, Akita-shi (JP); Hiroshi Ikeda, Tokyo (JO); Masahiro Kanai, Akita-shi (JP); Saburo Wakita, Noda-shi (JP)

(72) Inventors: Koji Tsuzukihashi, Akita-shi (JP); Hiroshi Ikeda, Tokyo (JO); Masahiro Kanai, Akita-shi (JP); Saburo Wakita, Noda-shi (JP)

(73) Assignees: MITSUBISHI MATERIALS ELECTRONIC CHEMICALS CO., LTD, Akita-shi, Akita (JP); MITSUBISHI MATERIALS CORPORATION, Tokyo (JP)

(21) Appl. No.: 13/636,490

(22) PCT Filed: Mar. 25, 2011
(86) PCT No.: PCT/JP2011/057355

§ 371 Date: Oct. 10, 2012

(30) Foreign Application Priority Data
Mar. 26, 2010 (JP) 2010-071699

(51) Int. Cl. C03B 5/23; C01B 33/02

(52) U.S. Cl. 423/348; 65/137

(57) ABSTRACT

A method for manufacturing a polycrystalline silicon ingot includes: solidifying a silicon melt retained in a crucible unidirectionally upward from a bottom surface of the silicon melt, wherein a silicon nitride coating layer is formed on inner surfaces of side walls and an inner side surface of a bottom of the crucible, a solidification process in the crucible is divided into a first region from 0 mm to X (10 mm≦X<30 mm) in hight, a second region from X to Y (30 mm≦Y<100 mm), and a third region of the Y or higher, with the bottom of the crucible as a datum, a solidification rate V1 in the first region is in a range of 10 mm/h≦V1≦20 mm/h, and a solidification rate V2 in the second region is in a range of 1 mm/h≦V2≦5 mm/h.

### CROSS-REFERENCE TO RELATED PATENT APPLICATIONS

This application is a U.S. National Phase Application under 35 U.S.C, §371 of International Patent Application No. PCT/JP2011/057355, filed Mar. 25, 2011, and claims the benefit of Japanese Patent Application No. 2010-071699, filed Mar. 26, 2010, all of which are incorporated by reference herein. The International Application was published in Japanese on Sep. 29, 2011 as International Publication No, WO/2011/118770 under PCT Article 21(2).

### FIELD OF THE INVENTION

The present invention relates to a method for manufacturing a polycrystalline silicon ingot which manufactures a polycrystalline silicon ingot by solidifying a silicon melt unidirectionally (by unidirectional solidification) in a crucible made of silica, and a polycrystalline silicon ingot which is obtained by the manufacturing method.

### BACKGROUND OF THE INVENTION

A polycrystalline silicon ingot is used as a material of a substrate for a solar cell, as described in, for example, Patent Document 1. That is, a polycrystalline silicon ingot is sliced to obtain a polycrystalline silicon wafer having a predetermined thickness, and then the polycrystalline silicon wafer is processed; and thereby, the substrate for the solar cell is manufactured. In the solar cell, the characteristics of the polycrystalline silicon ingot which is a material of the substrate for the solar cell have a great influence on performances such as conversion efficiency.

In particular, in the case where amounts of oxygen and impurities contained in polycrystalline silicon are large, the conversion efficiency of the solar cell is greatly reduced. Therefore, in order to keep the conversion efficiency of the solar cell at a high level, it is necessary to reduce the amounts of oxygen and impurities in the polycrystalline silicon which becomes the substrate for the solar cell.

With regard to a polycrystalline silicon ingot which is solidified unidirectionally in a crucible, that is, a polycrystalline silicon ingot which is obtained through sequential solidification toward a single fixed direction, the amounts of oxygen and impurities tend to become large in a bottom portion that is a solidification starting portion and a top portion that is a solidification ending portion. Therefore, in order to reduce the amounts of oxygen and impurities, the bottom portion and the top portion of the polycrystalline silicon ingot which is solidified unidirectionally are cut and removed.

The reason why each of the amounts of oxygen and impurities becomes large in the bottom portion and the top portion of the above-described polycrystalline silicon ingot will be described in detail below.

In the case where a silicon melt is solidified unidirectionally upward in a crucible, the solubility of impurities in a solid phase is lower than that in a liquid phase; and therefore, the impurities are discharged toward the liquid phase from the solid phase. For this reason, the amount of impurities in a solid phase portion becomes low. However, in the top portion of the above-described polycrystalline silicon ingot, that is a solidification ending portion, the amount of impurities becomes very high.

Furthermore, when a silicon melt is retained in a crucible made of silica, oxygen is mixed into the silicon melt from silica (SiO₂). Oxygen in the silicon melt is released from a liquid surface as SiO gas. Since oxygen is mixed from the bottom surface and the side surfaces of the crucible at the time of the start of solidification, the amount of oxygen in the silicon melt becomes large at the time of the start of solidification. When solidification from the bottom surface side proceeds and a solid-liquid interface rises, oxygen is mixed only from the side surfaces. Therefore, the amount of oxygen which is mixed in the silicon melt is gradually reduced and the amount of oxygen in the silicon melt is stabilized at a constant value. For the above-described reasons, the amount of oxygen becomes large in the bottom portion that is a solidification starting portion.

In view of these, as shown in, for example, Patent Document 2, there is provided a technique of suppressing the mixing of oxygen by using a crucible made of silica and having a Si₃N₄ coating layer formed on the inner surfaces (the side surfaces and the bottom surface) of the crucible.

In addition, conventionally, in the case of unidirectionally solidifying a polycrystalline silicon ingot, as described in Non-Patent Document 1, solidification has been performed at a constant solidification rate such as 0.2 mm/min (12 mm/h).

### PRIOR ART DOCUMENT

### Patent Document

Patent Document 1: Japanese Unexamined Patent Application Publication No. F110-245216
Patent Document 2: Japanese Unexamined Patent Application Publication No. 2001-198648

### Non-patent Document

Non-Patent Document 1: Noritaka Usami, Kentaro Kutsukake, Kozo Fujiwara, and Kazuo Nakajima; “Modification of local structures in multicrystals revealed by spatially resolved x-ray rocking curve analysis”, JOURNAL OF APPLIED PHYSICS 102, 103504 (2007)

### PROBLEMS TO BE SOLVED BY THE INVENTION

Recently, with respect to the solar cell, a further improvement in conversion efficiency has been required. For this reason, it is required to supply polycrystalline silicon having a lower oxygen concentration (specifically, an oxygen concentration of 4×10¹⁷ atoms/cm³ or less) than in the past.

In a conventional method for manufacturing a polycrystalline silicon ingot, the mixing of oxygen into a silicon melt can be suppressed by using a crucible having a Si₃N₄ coating layer formed thereon; however, it is not possible to completely prevent the mixing of oxygen. Therefore, as described above, an oxygen concentration becomes high on the bottom portion side that is a solidification starting portion. In the case where an upper limit value of the amount of oxygen in polycrystalline silicon as a product is set low, there is a need to lengthen a cut and removal quantity on the bottom portion side of a polycrystalline silicon ingot in order to fulfill the above-described upper limit value. In this case, the amount of polycrystalline silicon which is productized from one polycrystalline silicon ingot becomes small; and therefore, there is a problem in which the production efficiency of the polycrystalline silicon is greatly reduced.

The present invention has been made in view of the above-mentioned circumstances, and an object thereof is to provide a method for manufacturing a polycrystalline silicon ingot and a polycrystalline silicon ingot, and the method enables to greatly improve the production yield of polycrystalline silicon by reducing a portion in which an oxygen concentration becomes high in a bottom portion of the polycrystalline silicon ingot.

### SUMMARY OF THE INVENTION

### Means for Solving the Problems

There is provided a method for manufacturing a polycrystalline silicon ingot according to a first aspect of the invention which includes: solidifying a silicon melt retained in a crucible unidirectionally upward from a bottom surface of the silicon melt, wherein the crucible consists of silica, and a silicon nitride coating layer is formed on inner surfaces of side walls and an inner side surface of a bottom surface of the crucible, a solidification process in the crucible is divided into a first region from 0 mm to a height X, a second region from the height X to a height Y, and a third region of the height Y or more, when the bottom surface of the crucible is regarded as a datum, and the height X is in a range of 10 mm≦X<30 mm and the height Y is in a range of 30 mm≦Y<100 mm, and a solidification rate V1 in the first region is set to be in a range of 10 mm/h 5 V1 S 20 mm/h and a solidification rate V2 in the second region is set to be in a range of 1 mm/h≦V2<5 mm/h.

According to the method for manufacturing a polycrystalline silicon ingot having these features, the solidification process in the crucible is divided into the first region from 0 mm to the height X, the second region from the height X to the height Y, and the third region of the height Y or more, when the bottom of the crucible is regarded as a datum, and the solidification rates in the first region and the second region are defined.

Since the solidification rate V1 in the first region is set to be in a range of 10 mm/h≦V1≦20 mm/h which is relatively fast, a solid phase is quickly formed on a bottom portion of the crucible. Thereby, it is possible to suppress the mixing of oxygen from the bottom surface of the crucible into the silicon melt. In addition, since the height X of the first region is set to be in a range of 10 mm≦X<30 mm, it is possible to reliably suppress the mixing of oxygen from the bottom surface of the crucible into the silicon melt.

In the case where the solidification rate V1 is less than 10 mm/h, generation of crystal nuclei becomes insufficient; and thereby, it becomes impossible to smoothly carry out the unidirectional solidification. In the case where the solidification rate V1 exceeds 20 mm/h, it becomes impossible to lower (thin) the height X of the first region. For these reasons, the solidification rate V1 in the first region is set to be in a range of 10 mm/h≦V≦20 mm/h.

Furthermore, since the solidification rate V2 in the second region is set to be in a range of 1 mm/h≦V2≦5 mm/h which is relatively slow, it becomes possible to release oxygen in the silicon melt from a liquid surface in the second region. Thereby, it is possible to greatly reduce the amount of oxygen in the silicon melt.

In addition, since the height Y of the first region and the second region is set to be in a range of 30 mm≦Y<100 mm, the length of a portion where the amount of oxygen is large can be shortened. Therefore, it is possible to greatly improve the production yield of polycrystalline silicon which becomes a product.

In the case where the solidification rate V2 is less than 1 mm/h, there is a possibility that a solid phase may be re-melted.

In the case where the solidification rate V2 exceeds 5 mm/h, it becomes impossible to sufficiently release oxygen. For these reasons, the solidification rate V2 in the second region is set to be in a range of 1 mm/h≦V2≦5 mm/h.

Here, it is preferable that a height Y−X of the second region be set to be in a range of 10 mm≦Y−X≦40 mm.

In this case, since the height Y−X of the second region fulfills Y−X≧10 mm, the time to release oxygen in the silicon melt to the outside is secured. Therefore, it is possible to reliably reduce the amount of oxygen in the polycrystalline silicon ingot. On the other hand, since the height Y−X of the second region fulfills Y−X≦40 mm, it is possible to reliably shorten the length of a portion where the amount of oxygen is large.

It is preferable that a solidification rate V3 in the third region be set to be in a range of 5 mm/h≦V3≦30 mm/h.

In this case, since the solidification rate V3 in the third region fulfills V3≧5 mm/h, it is possible to secure the production efficiency of the polycrystalline silicon ingot. On the other hand, since the solidification rate V3 in the third region fulfills V3≦30 mm/h, it is possible to smoothly carry out the unidirectional solidification.

There is provided a polycrystalline silicon ingot according to a second aspect of the invention which is manufactured by the above-described method for manufacturing a polycrystalline silicon ingot, wherein an oxygen concentration in a cross-sectional central portion of a portion which is 30 mm high from a bottom portion of the polycrystalline silicon ingot that is in contact with a bottom surface of a crucible is in a range of 4×10¹⁷ atoms/cm³ or less.

In the polycrystalline silicon ingot having these features, the oxygen concentration in the cross-sectional central portion of the portion which is 30 mm high from the bottom portion of the polycrystalline silicon ingot is in a range of 4×10¹⁷ atoms/cm³ or less, and the bottom portion of the polycrystalline silicon ingot has been in contact with the bottom surface of the crucible. Therefore, even the portion which is 30 mm high from the bottom portion can be used as a product such as polycrystalline silicon wafers.

### Effects of the Invention

As described above, according to the invention, it is possible to provide a method for manufacturing a polycrystalline silicon ingot and a polycrystalline silicon ingot, and the method enables to greatly improve the production yield of polycrystalline silicon by reducing a portion having a high oxygen a in a bottom portion.

### BRIEF DESCRIPTION OF THE DRAWINGS

FIG. 1 is a schematic explanatory diagram of a polycrystalline silicon ingot of an embodiment of the invention.

FIG. 2 is a schematic explanatory diagram of an apparatus for manufacturing a polycrystalline silicon ingot which is used to manufacture the polycrystalline silicon ingot shown in FIG. 1.

FIG. 3 is a schematic explanatory diagram of a crucible which is used in the apparatus for manufacturing a polycrystalline silicon ingot shown in FIG. 2.

FIG. 4 is an explanatory diagram showing a solidification state of a silicon melt in the crucible shown in FIG. 3.

FIG. 5 is a pattern diagram showing the setting of a solidification rate in a method for manufacturing a polycrystalline silicon ingot of the embodiment of the invention.

FIG. 6 is a diagram showing measurement results of amounts of oxygen in polycrystalline silicon ingots in examples.

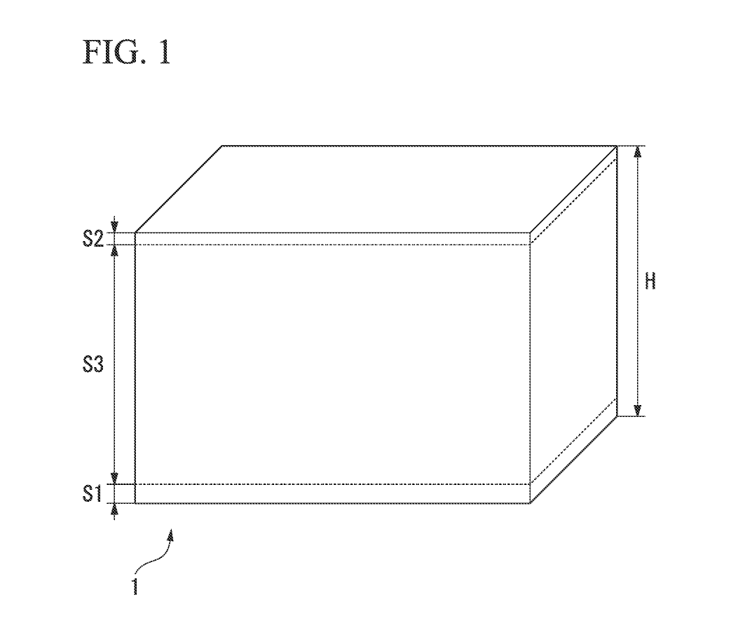

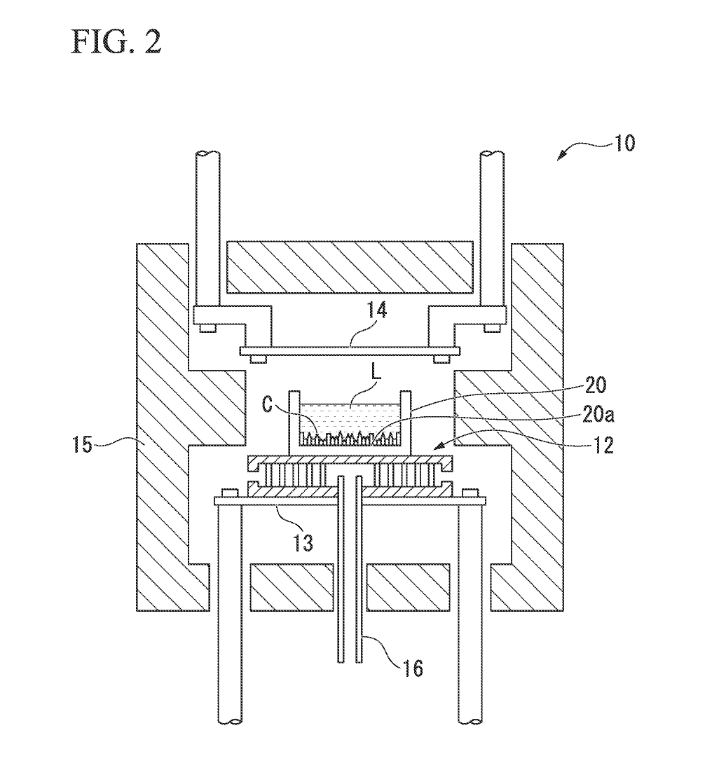

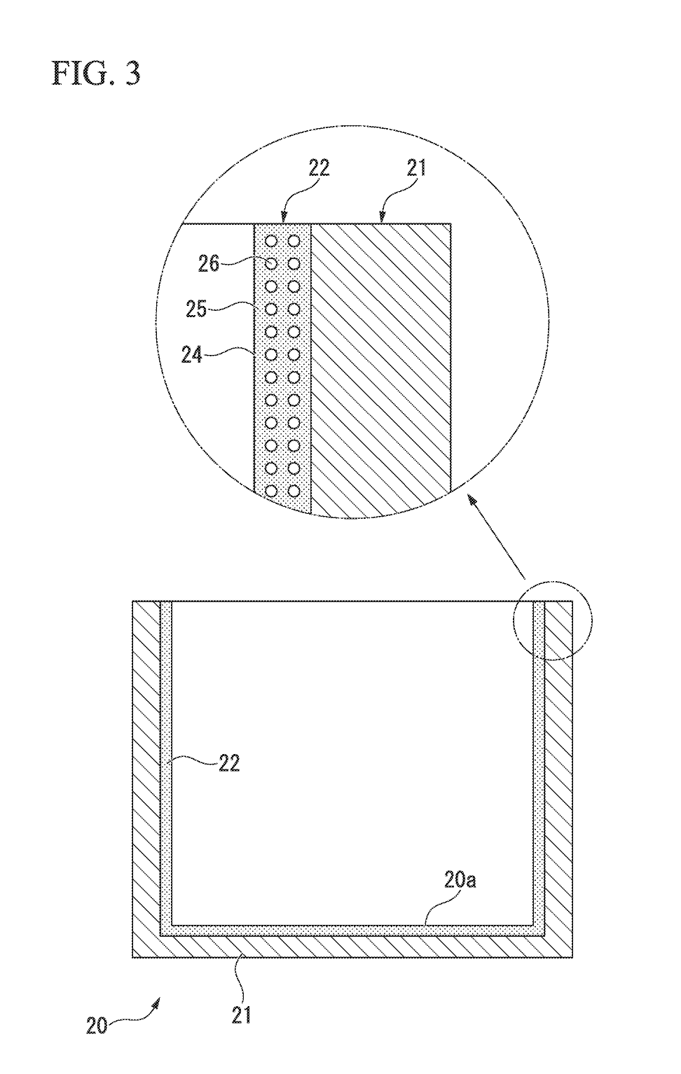

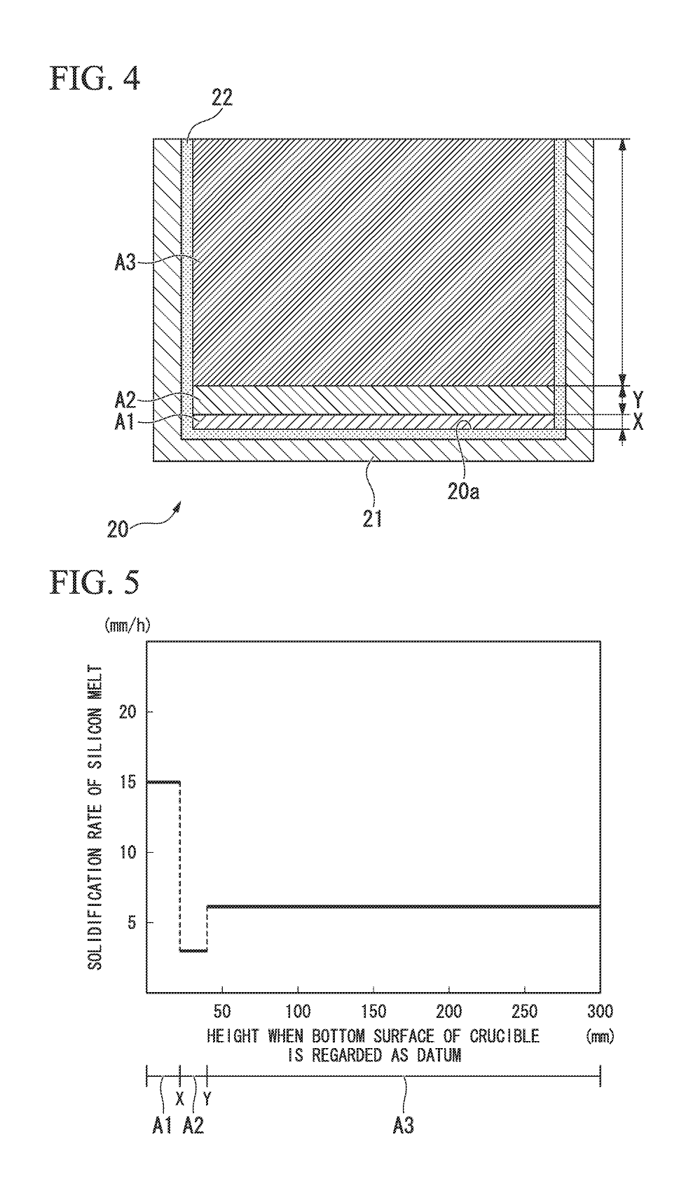

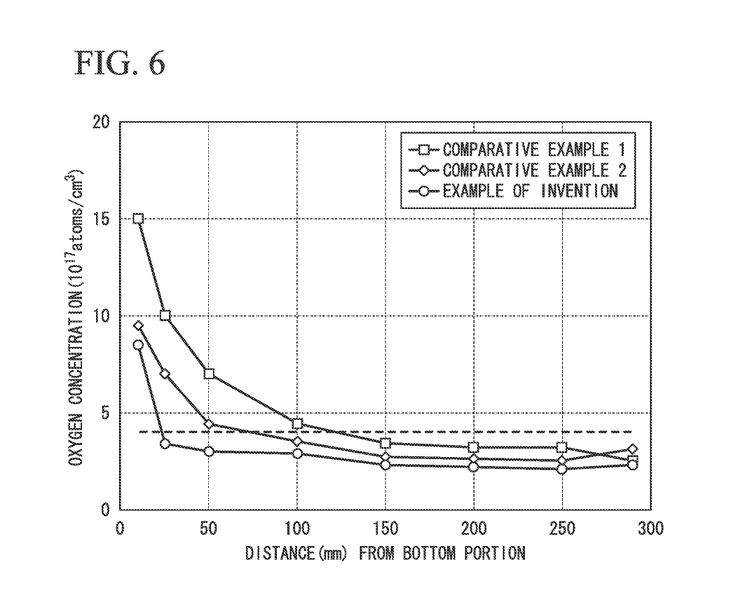

1. A method for manufacturing a polycrystalline silicon ingot, comprising:
a process of solidifying a silicon melt retained in a crucible unidirectionally upward from a bottom surface of the silicon melt, wherein
the crucible consists of silica,
a silicon nitride coating layer is formed on inner surfaces of side walls and an inner side surface of a bottom surface of the crucible,
the solidification process in the crucible is divided into a first region from 0 mm to a height X, a second region from the height X to a height Y, and a third region of the height Y or higher, when the bottom surface of the crucible is regarded as a datum, and the height X is in a range of 10 mm≦X<30 mm and the height Y is in a range of 30 mm≦Y<100 mm, and
a solidification rate V1 in the first region is set to be in a range of 10 mm/h≦V1≦20 mm/h and a solidification rate V2 in the second region is set to be in a range of 1 mm/h≦V2 5 mm/h.

2. The method for manufacturing a polycrystalline silicon ingot according to claim 1, wherein a height Y−X of the second region is set to be in a range of 10 mm≦Y−X≦40 mm.

3. The method for manufacturing a polycrystalline silicon ingot according to claim 1, wherein a solidification rate V3 in the third region is set to be in a range of 5 mm/h≦V3≦30 mm/h.

4. A polycrystalline silicon ingot manufactured by the method for manufacturing a polycrystalline silicon ingot according to claim 1,
wherein an oxygen concentration in a cross-sectional central portion of a portion, which is 30 mm high from a bottom portion of the polycrystalline silicon ingot that is in contact with a bottom surface of a crucible, is in a range of 4×10¹⁷ atoms/cm³ or less.

5. The method for manufacturing a polycrystalline silicon ingot according to claim 2, wherein a solidification rate V3 in the third region is set to be in a range of 5 mm/h≦V3≦30 mm/h.

6. A polycrystalline silicon ingot manufactured by the method for manufacturing a polycrystalline silicon ingot according to claim 2,
wherein an oxygen concentration in a cross-sectional central portion of a portion which is 30 mm high from a bottom portion of the polycrystalline silicon ingot that is in contact with a bottom surface of a crucible is in a range of 4×10¹⁷ atoms/cm³ or less.

7. A polycrystalline silicon ingot manufactured by the method for manufacturing a polycrystalline silicon ingot according to claim 3,
wherein an oxygen concentration in a cross-sectional central portion of a portion which is 30 mm high from a bottom portion of the polycrystalline silicon ingot that is in contact with a bottom surface of a crucible is in a range of 4×10¹⁷ atoms/cm³ or less.
